(19) United States
(12) Patent Application Publication
(10) Pub. No.: US 2010/0023399 A1
(43) Pub. Date: Jan. 28, 2010

(54) Personalized Advertising Using Lifestreaming Data

(76) Inventors: Saurabh Sahni, Bangalore (IN); Pankaj Kothari, Bangalore (IN)

Correspondence Address: STATTLER - SUH PC, 60 SOUTH MARKET STREET, SUITE 480, SAN JOSE, CA, 95113, US

(21) Appl. No.: 12/177,675

(22) Filed: Jul. 22, 2008

(51) Int. Cl. G06Q 30/00

(52) U.S. Cl. 705/14.53

(57) ABSTRACT

This patent discloses a method to increase the relevance of advertisements displayed on the Internet. An ad server may receive a request for an advertisement from a web server. The ad server may compare metadata to online advertisements within an ad database. The metadata may include data about the user obtained from at least two websites through a lifestreaming process. The comparison may seek out a best match between the advertisements and the metadata and serve the resulting advertisement to the web server.

### BACKGROUND

1. Field

The information disclosed in this patent relates to displaying an Internet advertisement as a function of the activities of a user tracked across the Internet over multiple websites.

2. Background Information

The marketing of products and services online over the Internet through advertisements is big business. In February 2008, the IAB Internet Advertising Revenue Report conducted by PricewaterhouseCoopers announced that PricewaterhouseCoopers anticipated the Internet advertising revenues for 2007 to exceed US$21 billion. With 2007 revenues increasing 25 percent over the previous 2006 revenue record of nearly US$16.9 billion, Internet advertising presently is experiencing unabated growth.

Unlike print and television advertisement that primarily seeks to reach a target audience, Internet advertising seeks to reach target individuals. The individuals need not be in a particular geographic location and Internet advertisers may elicit responses and receive instant responses from individuals. As a result, Internet advertising is a much more cost effective channel in which to advertise.

Many websites host advertisements of others as a way to generate revenue. Goals of online advertising include increasing click through rates to improve sales for the advertisers and to enhance user experiences on the websites they visit. What is needed is a system to address these and other issues.

### SUMMARY

This patent discloses a method to increase the relevance of advertisements displayed on the Internet. An ad server may receive a request for an advertisement from a web server. The ad server may compare metadata to online advertisements within an ad database. The metadata may include data about the user obtained from at least two websites through a lifestreaming process. The comparison may seek out a best match between the advertisements and the metadata and serve the resulting advertisement to the web server.

### BRIEF DESCRIPTION OF THE FIGURES

FIG. 1 is a block diagram illustrating a system 100.

FIG. 2 is a block diagram illustrating a system 200.

FIG. 3 is a block diagram illustrating system 100 with details of metadata 114.

FIG. 4 is a method 400 to compile user personal profiles 204 utilizing system 200.

FIG. 5 is a method 500 to display an online advertisement 102 to user 10 utilizing system 100.

### DETAILED DESCRIPTION

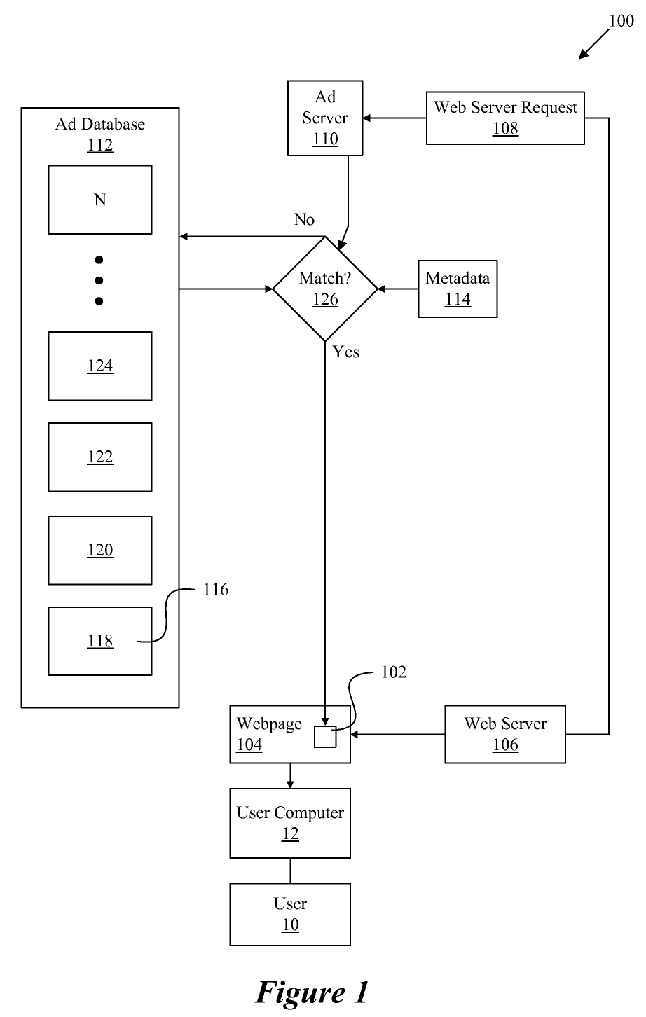

FIG. 1 is a block diagram illustrating a system 100. System 100 may be a group of independent but interrelated elements that may work to increase the relevance of an advertisement 102 displayed to a user 10 on a webpage 104. Increasing the relevance of an advertisement displayed online to a user is important because each display—each advertising impression made on a computer screen—may mean that an advertiser has purchased that advertising impression and any resulting click throughs.

On the Internet, advertising impressions reach into the millions rather quickly and each of those millions of advertising impressions may represent millions of purchases by the advertiser. By increasing the relevance of each advertising impressions to the viewer, system 100 may increase the likelihood that a prospective customer 10 may take the advertiser's intended action, such as by clicking on the advertisement or otherwise doing as the advertisement requests. Here, system 100 may improve the return over investment for the advertiser, increase the web browsing experience of user 10, and provide additional profit for the company managing the online advertising account of the advertiser.

In operation, user 10 may engage a user computer 12 to request that a particular webpage 104 be displayed on user computer 12. The request may be sent to a web server 106. Web server 106 may send a web server request 108 to an ad server 110 to provide an advertisement for display on webpage 104.

Ad server 110 may be in communication with web server 106, an ad database 112, and metadata 114. Ad database 112 may have a plurality of advertisements 116, including advertisements 118, 120, 122, 124, through N advertisement. Metadata 114 may include lifestreaming data and data provide as part of web server request 108.

Lifestreaming may be a process to collect and store information about a person's activities and life by aggregating online content that the person creates and consumes, such as blog posts, social network updates, online photos, videos, bookmarks, etc. Lifestreaming data may be a collection of terms resulting from the lifestreaming process that may represent the activities of user 10 on websites throughout the Internet, including websites not hosted by web server 106 and ad server 110. The use of lifestreaming data may allow system 100 to personalize an advertisement for each individual user 10 to increase the click through revenue rate significantly. Ad server 110 may used a decision device 126 to compare metadata 114 to advertisements 116 to select that advertisement 116 that may be most relevant to user 10. When advertisement 102 is located, ad server 110 may serve advertisement 102 into webpage 104 for viewing by user 10 on user computer 12.

Advertisement 102 may be an announcement called to the attention of the public 10. For example, advertisement 102 may include an announcement to make something known, especially to persuade people 10 to buy whatever is advertised. Advertisement 102 may be a communication to inform potential customers 10 about products and services, about how to obtain them, and use them. Advertisement 102 may be an online advertisement when displayed on an Internet webpage. As display advertising-content appearing on a webpage, advertisement 102 may be in a form such as text, a banner, a half banner, a streaming banner, a button, an interactive button ad, a clickable ad, mail, raw text, a rectangle, and a skyscraper and may range in size from 25×25 to 728×210, for example. Advertisement 102 may be in any other possible sizes or ad forms.

Webpage 104 may be a resource of information in web server 106 accessed through a web browser. A web browser is a software application on user computer 12 that may enable user 10 to display and interact with text, images, videos, music, and other information located on webpage 104. The information may be in a HyperText Markup Language (HTML) format or any other browser interpretable format. Webpage 104 may provide navigation to other webpages through hypertext links and advertisement 102.

Web server 106 may include a web server computer program to accept HTTP requests from user computer 12 and to serve an HTTP response along with optional data content to user computer 12. Web server 106 may include a computer that runs the web server computer program. Web server 106 may construct the HTML for each web page when it is requested by a user computer 12.

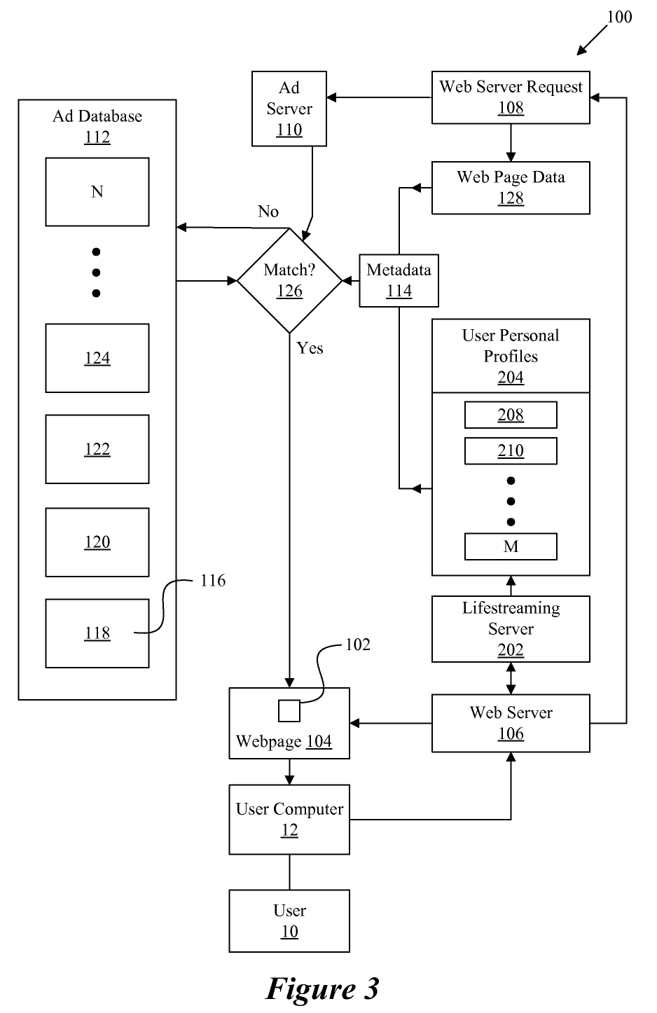

Web server request 108 may be a message sent to ad server 110 that requests an advertisement 116 for display on webpage 104. Included with the request 108 may be web page data 128 (FIG. 3). Web page data 128 may include information about user 10, such as the identity (e.g., name, age, gender) and location of user 10, the date and location time of the web page request from user 10, and metadata characterizing the particular web page requested.

Ad server 110 may include a computer server, such as a web server, that may store advertisements 116 used in online marketing and may deliver them to website visitors 10 by placing an advertisement 102 on webpage 104. In addition to updating the contents of web server 106 so that the website or webpage on which the ads are displayed may contain new advertisements 102, ad server 110 may perform various other tasks such as counting the number of impressions/clicks for an ad campaign and report generation. The ad server may be a local ad server run by a single publisher and serve ads to that publisher's domains or may be a third-party, remote ad server that serve ads across domains that may be owned by multiple publishers. Ad server 110 may be in communication with and have control over ad database 112 and metadata 114.

Ad database 112 may be a structured collection of records. Each record may be an advertisement object 114 having a list of metadata that may characterize the advertisement. Advertisements 116 may be very specific, such as “Tickets for the 9:00 PM showing of the 2001 movie Screech now are available in Mxim Theater located in Kansas City, Mo.” Advertisements 118, 120, 122, 124, through N advertisement may differ from each other by at least one metadata item.

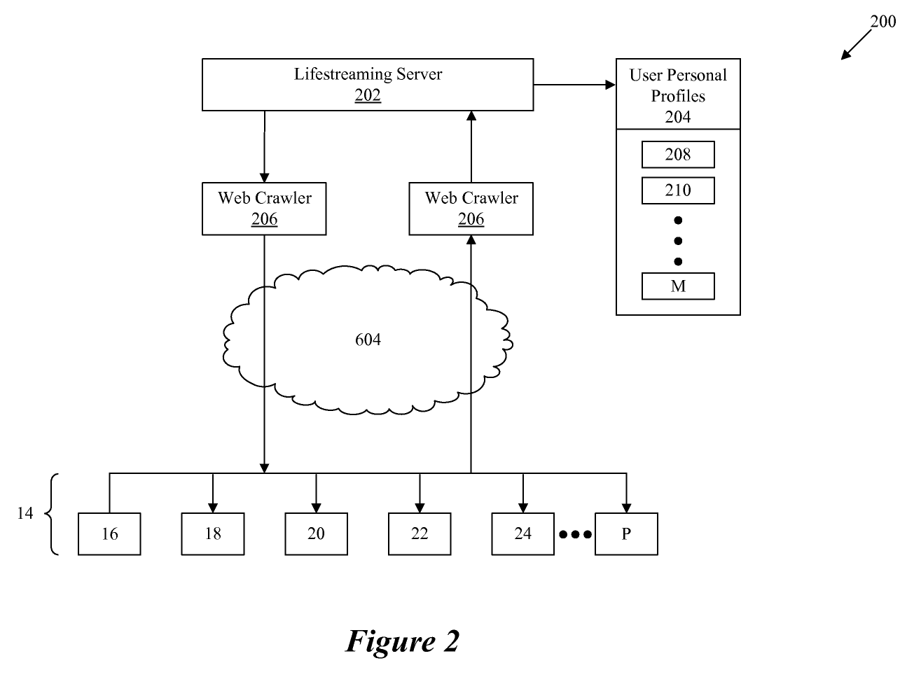

Metadata 114 may include data about activities and requests of user 10. Metadata 114 may include lifestreaming data from system 200 (FIG. 2 and FIG. 3). In addition metadata 114 may include data provide as part of web server request 108 (FIG. 3).

Decision device 126 may include software to compare metadata 114 with each set of metadata that may characterize each advertisement 116. Decision device 126 may determine whether there may be a match between metadata 114 and an advertisement 116. If a particular advertisement 116 is a closest match to metadata 114, then decision device 126 may determine that that advertisement 116 is a most relevant advertisement to user 10. Ad server 110 then may select that advertisement 116 to be served into webpage 104 as advertisement 102.

FIG. 2 is a block diagram illustrating a system 200. System 200 may be a group of independent but interrelated elements that may work to retrieve and store data about user 10 prior to user 10 requesting webpage 104 (FIG. 1). System 200 may include lifestreaming server 202, user personal profiles database 204, and a web crawler 206. Lifestreaming server 202 may be in communication with user personal profiles database 204 and web crawler 206.

Lifestreaming server 202 may obtain content generated by user 10 over several websites 14. Websites 14 may include websites 16, 18, 20, 22, 24, through P websites and each website 14 may include an entire collection of web pages and other information made available through what appears to user 10 as a single web server. Websites 14 may be under the control of an entity other than both the entity that may control web server 106 and the entity that may control ad server 110. Two or more of websites 14 may be under the control of two different entities. For example, first website 16 may be controlled by a first business entity and second website 18 may be controlled by a second business entity, where the first business entity may be unrelated to the second business entity such that neither business entity may have final control over the other's website. The obtained content may be stored in user personal profiles database 204.

User personal profiles database 204 may be a database maintained by lifestreaming server 202 to store a structured collection of records. User personal profiles database 204 may include a first user personal profile 208, a second user personal profile 210, through M user personal profiles. Each user personal profile 204 may include user lifestreaming data that may characterize an individual online identification. An individual online identification may correspond to a single person visiting multiple websites.

Web crawler 206 may be a program that travels over network 604 (FIG. 6) to visit and read the webpages and other information at each website 14 in search of information about user 12. In one example, web crawler 206 may compile lifestreaming data created by a first user 10 on website 16, website 18, website 20, website 22, and then website 24 and return that information to first user personal profile 208. The lifestreaming data may include metadata associated with the first user 10 found from content generated by the user across several social sites.

FIG. 3 is a block diagram illustrating system 100 with details of metadata 114. Metadata 114 may include webpage data 128 and data from user personal profiles database 204. Webpage data 128 may be contributed to metadata 114 from web server request 108. Ad server 110 may tap both webpage data 128 as a first parameter and data from user personal profiles database 204 as a second parameter and use both parameters in decision device 126.

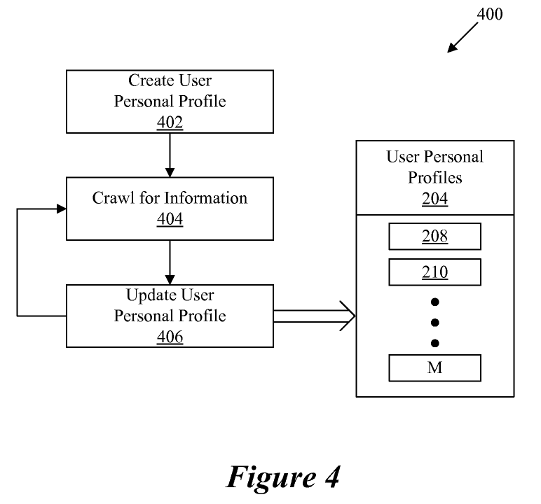

FIG. 4 is a method 400 to compile user personal profiles 204 utilizing system 200. At step 402, system 100 may create a first user personal profile 208 related to a first user 10. On the Internet, users may need to identify themselves for the purposes of accounting, security, logging, and resource management. In order to identify oneself, a user may have an account (a user account) and a username employ to access systems. At a minimum, user personal profile 208 may include an online username. User 10 may input the online username input into user personal profile 208 or the username may be retrieved by crawler 206 or by some other technique.

At step 404, system 100 may crawl for more information about first user 10. Users may provide their usernames of different websites 14, such as those that may host online community platforms. Crawlers 206 may extract information from two or more websites 14. For example, if user 10 visits the five websites 16-24, crawlers 206 may extract information from those five websites. In one example, system 100 may send out crawler 206 to retrieve user activity associated with a particular username.

At step 406, retrieved information about first user 10 may be stored in user personal profile 208 within user personal profiles database 204. In an example, aggregate updates for first user 10 may be retrieved from a lifestreaming provider and stored in user personal profile 208. In another example, application programming interfaces (APIs) may be utilized to find profile and metadata associated with the current visitor.

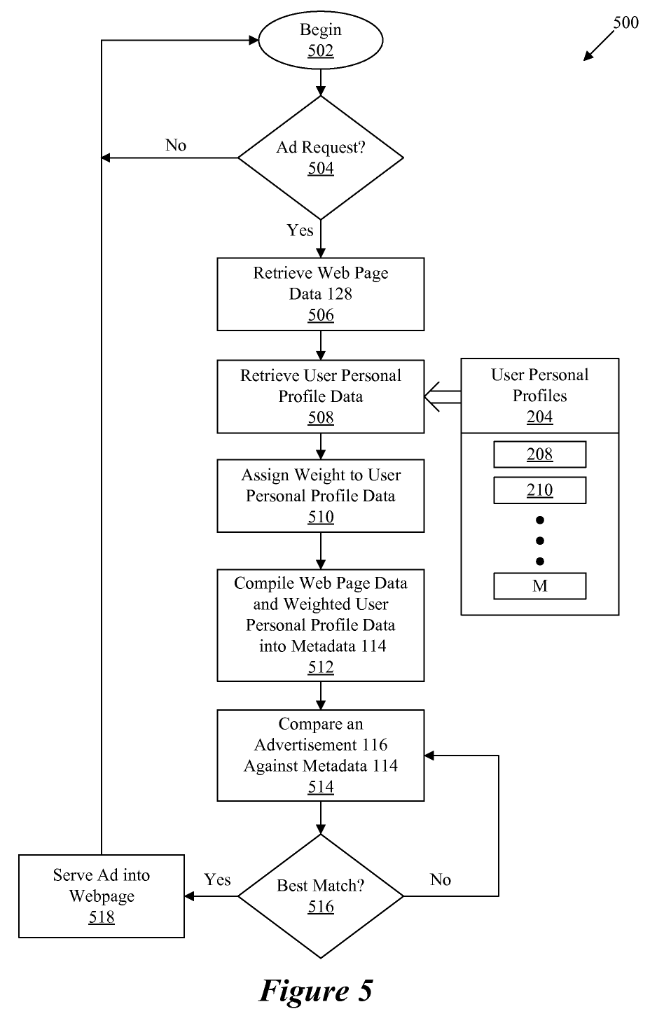

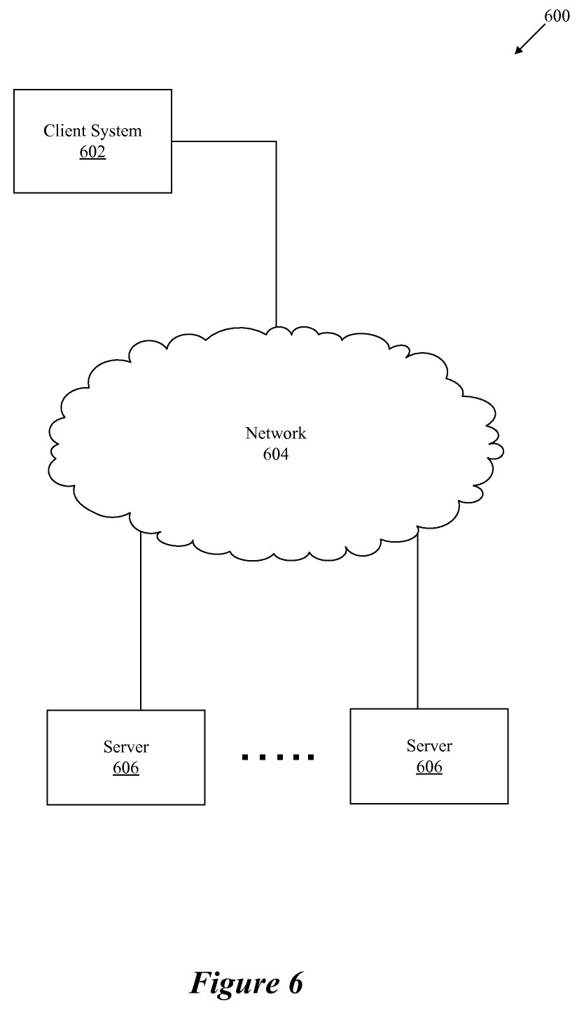

FIG. 5 is a method 500 to display an online advertisement 102 to user 10 utilizing system 100. Method 500 may work to select and display that advertisement which may be most relevant to a user based on the present activity of the user and past activity of the user. At step 502, method 500 may begin. At step 504, method 500 may determine whether ad server 110 has received a web server request 108 from web server 106. For example, when user computer 12 requests display of a webpage from a website hosted by web server 104, web server 104 may notify ad server 110 of this through web server request 108. A purpose of this is to display an advertisement 116 so that both the entities operating ad server 110 and web server 106 may share in the advertising revenue resulting from the ad display.

If ad server 110 has not received a web server request 108 from web server 106, method 500 may return to step 502. If ad server 110 has received a web server request 108 from web server 106, then method 500 may proceed to step 506. Web page data 128 may be included with web server request 108. As noted above, web page data 128 may include information about user 10, such as the identity (e.g., name, age, gender) and location of user 10, the date and location time of the web page request from user 10, and metadata characterizing the particular web page requested. At step 506, method 500 may retrieve web page data 128. Method 500 may retrieve lifestreaming metadata from user personal profile 208 at step 508.

At step 510, system 100 may assign a weight to each piece of retrieved metadata within user personal profile 208 as a function of the metadata contained within webpage data 128. For example, if user 10 had entered a request related to cameras, such information would be included with the metadata contained within webpage data 128 and each piece of metadata within user personal profile 208 related to cameras would be given more weight than metadata not related to cameras. If the request of user 10 included an indication that user 10 was looking to buy, rent, or window shop cameras, then each piece of metadata within user personal profile 208 additionally would be weighted according to this information.

At step 512, method 500 may compile retrieved web page data and weighted user personal profile data into metadata 114. At step 514, method 500 may compare metadata 114 against an advertisement 116 in ad database 112. In addition to metadata from web page data 128, metadata 114 typically may include information about user 10 from two or more websites. At step 516, system 100 may determine whether the compared advertisement is a best match to metadata 114. This may include determining how many keywords associated with an online advertisement 116 match metadata associated with the lifestreaming data in user personal profile 208. If the compared advertisement is not a best match to metadata 114, then method 500 may return to step 514. If the compared advertisement is a best match to metadata 114, then the advertisement may be deemed advertisement 102 and method 500 may proceed to step 518.

At step 518, ad server 110 may serve advertisement 102 into webpage 104 for viewing user 10. Here, a preexisting ad 114 may be selected or modified at runtime with information from user personal profile 208. Typically, advertisement 102 and a remainder of webpage 104 may be timed to come together for display shortly after user 10 requests webpage 104. From step 518, method 500 may return to step 502.

### EXAMPLE 1

Consider a scenario where system 100 has retrieved application programming interfaces (APIs) from a popular online Digital Video Disc (DVD) rental service and those APIs demonstrate that user Bob has tendency to rent movies on weekends. In addition, system 100 previously retrieved a message posted by Bob on a free social networking and micro-blogging service, where the message as “Watching movie in Mxim Theater, 5800 Zoo Drive, Kansas City, Mo.” In more recent retrievals, system 100 has obtained metadata that indicates Bob has been listening to songs from the movie Screech on a United Kingdom-based Internet radio and music community website. Bob also had identified a trailer of the movie Screech on a video sharing website as being a favorite trailer. Today, Friday and the first day of the weekend, Bob has requested a webpage 104 (FIG. 1) that details new movie releases and includes a position for an advertisement 116. With all above personal data about Bob's activity maintained as metadata 114, system 100 may use metadata 114 to retrieve an advertisement 116 from ad database 112 that may be closest to “Buy tickets for movie Screech in Mxim Theater.” The ad then may be served into webpage 104. Here, system 100 may bring together Bob's present activity (the Friday webpage request), previously collected lifestreaming data representing disparate activates of Bob, and a database of advertisements 116 and use lifestreaming data to present a personalized advertisement to Bob that Bob may find most relevant to his present situation. In turn, a probability of Bob clicking on the advertisement increases significantly.

### EXAMPLE 2

Consider another scenario, where system 100 has retrieved metadata to establish that Bob is a friend of Alice on different social networks. System 100 then retrieves metadata from a first social networking site indicating that Alice has submitted a positive review on the first social networking site of Ocean Star, a Chinese restaurant in Kansas City, Mo. System 100 retrieves photo metadata from photos added by Alice to an image and video hosting website with tags Alice, Bob, Ocean Star and then retrieves metadata from a blogger community social network that indicates that Bob has been tagged “Chinese” by ten users on the blogger community social network. After few days, Bob is looking on a site showing contact information of local restaurants with different cuisines. On this site, an advertisement of “Ocean Star” may have a higher probability of being clicked by Bob then advertisements of any other local restaurant that could be taken from ad database 112.

### EXAMPLE 3

The metadata about a user obtained from several sources may help in serving the most relevant advertisements when combined with user basic profile knowledge and contextual knowledge. Contextual knowledge may include metadata associated with a webpage on which advertisement may be served. The several sources may include user tags on social networks such as blogger community social networks, social bookmarking websites, personal bogs, image and video hosting websites, video sharing websites, Internet radio and music community websites, online auction, shopping, and e-commerce websites, online DVD rental services, social cataloging websites, and social event calendar websites. For example, advertisements related to travel/hotel deals for the date and venue of that event will be of more interest to the user in those situations where system 100 (FIG. 1) has retrieved metadata indicating that a user marked an event as attending on upcoming. In addition, a user's existing job information like location and designation at a business-oriented social networking site may be used to provide relevant job advertisements to the user.

FIG. 6 illustrates a network environment 600 for operation of system 100. The network environment 600 may include a client system 602 coupled to a network 604 (such as the Internet, an intranet, an extranet, a virtual private network, a non-TCP/IP based network, any LAN or WAN, or the like) and server systems 6061 to 606N. A server system may include a single server computer or a number of server computers. Client system 602 may be configured to communicate with any of server systems 6061 to 606N, for example, to request and receive base content and additional content (e.g., in the form of photographs).

Client system 602 may include a desktop personal computer, workstation, laptop, PDA, cell phone, any wireless application protocol (WAP) enabled device, or any other device capable of communicating directly or indirectly to a network. Client system 602 typically may run a web-browsing program that may allow a user of client system 602 to request and receive content from server systems 6061 to 606N over network 604. Client system 602 may one or more user interface devices (such as a keyboard, a mouse, a roller ball, a touch screen, a pen or the like) to interact with a graphical user interface (GUI) of the web browser on a display (e.g., monitor screen, LCD display, etc.).

In some embodiments, client system 602 and/or system servers 6061 to 606N may be configured to perform the methods described herein. The methods of some embodiments may be implemented in software or hardware configured to optimize the selection of additional content to be displayed to a user. In one example, client system 602 and/or system servers 6061 to 606N may include or be part of ad server 110.

System 100 works to solve the problem of providing highly relevant advertisements to the end user. By combining the contextual knowledge—general knowledge about the request environment and the web page—as well as the information extracted from the user activities across the web, system 100 may improve advertisement click through rate to enhance ad-hosting revenue further.

The used lifestreaming data may be part of a disbursed online record of the activities of a person, either via direct video feed or via aggregating the person's online content such as blog posts, social network updates, and online photos. Lifestreaming metadata may be crawled in advance of displaying an advertising object to derive user interests as a first parameter. As used in system 100, lifestreaming may enable aggregation of user activities of several social website to increase the relevance of an advertisement 116 to user 10. Here, system 100 may utilize lifestreaming to deliver personalized advertisements using the metadata associated with the user, found from the user-generated content, across several social sites. These personalized advertisements may increase the click through rate and in-turn revenue significantly. The lifestreaming metadata also may enable websites to personalize content according to the user activities.

Activities outside of a website hosting the ad server may be referred to as third party activities from a perspective of the ad server. An initial user profile may be obtained from information already within the website hosting the ad server and may be enriched and enhanced by crawlers. System 100 may collect the activity information of a user on websites visited by that user, correlate that information with metadata and match that with keywords used for advertising to derive a more relevant advertisement for display to the user at whatever webpage the user currently is viewing. This may be done on the third party side in the sense that the ad server may track user activities across the Internet and display a relevant ad to whatever third party webpage the user currently is viewing.

The information disclosed herein is provided merely to illustrate principles and should not be construed as limiting the scope of the subject matter of the terms of the claims. The written specification and figures are, accordingly, to be regarded in an illustrative rather than a restrictive sense. Moreover, the principles disclosed may be applied to achieve the advantages described herein and to achieve other advantages or to satisfy other objectives, as well.

What is claimed is:

1. A method to display an online advertisement to a user, the method comprising:
presenting an ad database having a plurality of online advertisements; and
comparing metadata to at least two of the online advertisements to determine the online advertisement to be displayed to the user, where the metadata includes lifestreaming data about the user obtained from at least two websites.

2. The method of claim 1, where the metadata further includes webpage data.

3. The method of claim 2, the method further comprising:
assigning a weight to each piece of lifestreaming data as a function of the data contained within the webpage data.

4. The method of claim 1, where comparing metadata to at least two of the online advertisements includes comparing the lifestreaming data as a first parameter and webpage data as a second parameter to at least two of the online advertisements.

5. The method of claim 1, where comparing metadata to at least two of the online advertisements is a data/online advertisements comparison, the method further comprising:
obtaining all the lifestreaming data used in the data/online advertisements comparison prior to comparing metadata to at least two of the online advertisements.

6. The method of claim 1, where comparing metadata to at least two of the online advertisements is performed by an ad server and where the lifestreaming data about the user is contained in a user personal profile, the method further comprising:
crawling a website for information about the user;
updating the user personal profile with information about the user received from crawling;
determining whether the ad server has received a web server request from a web server; and
if the ad server has not received a web server request from a web server, then determining whether the ad server has received a web server request from a web server.

7. The method of claim 1, where comparing metadata to at least two of the online advertisements includes determining how many keywords associated with an online advertisement match metadata associated with the lifestreaming data.

8. A computer readable medium comprising a set of instructions which, when executed by a computer, cause the computer to display an online advertisement to a user, the instructions for:
presenting an ad database having a plurality of online advertisements; and
comparing metadata to at least two of the online advertisements to determine the online advertisement to be displayed to the user, where the metadata includes lifestreaming data about the user obtained from at least two websites.

9. The computer readable medium of claim 8, where the metadata further includes webpage data.

10. The computer readable medium of claim 9, where the lifestreaming data about the user is contained in a user personal profile, the computer readable medium further comprising:
assigning a weight to each piece of lifestreaming data as a function of the data contained within the webpage data.

11. The computer readable medium of claim 9, where comparing metadata to at least two of the online advertisements includes comparing the lifestreaming data as a first parameter and the webpage data as a second parameter to at least two of the online advertisements.

12. The computer readable medium of claim 8, where comparing metadata to at least two of the online advertisements is a data/online advertisements comparison, the computer readable medium further comprising:
obtaining all the lifestreaming data used in the data/online advertisements comparison prior to comparing metadata to at least two of the online advertisements.

13. The computer readable medium of claim 8, where comparing metadata to at least two of the online advertisements is performed by an ad server and where the lifestreaming data about the user is contained in a user personal profile, the computer readable medium further comprising:
crawling a website for information about the user;
updating the user personal profile with information about the user received from crawling;
determining whether the ad server has received a web server request from a web server; and
if the ad server has not received a web server request from a web server, then determining whether the ad server has received a web server request from a web server

14. The computer readable medium of claim 8, where comparing metadata to at least two of the online advertisements includes determining how many keywords associated with an online advertisement match metadata associated with the lifestreaming data.

15. An ad server to display an online advertisement to a user, the ad server comprising:
a decision device to compare metadata to at least two of the online advertisements stored within an ad database, where the metadata includes lifestreaming data from a user personal profiles database, where the decision device and user personal profiles database are in communication with each other, and where the lifestreaming data is about the user and has been obtained from at least two websites.

16. The ad server of claim 15, further comprising:
an ad database having a plurality of online advertisements, where the ad database is in communication with the decision device.

17. The ad server of claim 15, where the metadata further includes webpage data.

18. The ad server of claim 17, where the ad server is in communication with a lifestreaming server to receive the lifestreaming data, where the lifestreaming data is contained in a user personal profile, and where each piece of lifestreaming data includes a weight as a function of the data contained within the webpage data.

19. The ad server of claim 19, where the user personal profiles database includes a plurality of user personal profile.

20. The ad server of claim 15, where the at least two websites includes a first website controlled by a first business entity and a second website controlled by a second business entity, where the first business entity is unrelated to the second business entity.
